(19) United States
(12) Patent Application Publication
(10) Pub. No.: US 2002/0084382 A1
(43) Pub. Date: Jul. 4, 2002

(54) Aircraft deicer

(76) Inventor: James H. Crist, Canton, OH (US)

Correspondence Address: Cynthia S. Murphy, Renner, Otto, Boisselle, & Sklar, L.L.P., 19th Floor, 1621 Euclid Avenue, Cleveland, OH, 44115, US

(21) Appl. No.: 09/995,242

(22) Filed: Nov. 27, 2001

Related U.S. Application Data
(60) Provisional application No. 60/253,396, filed on Nov. 27, 2000.

(51) Int. Cl. B64D 15/00

(52) U.S. Cl. 244/134 B

(57) ABSTRACT

A pneumatic deicer (10) which can withstand temperatures in excess of about 200° F., in excess of about 300° F. and in excess of about 400° F. whereby it can be used on the guide vane surfaces (14) of jet engines. The deicer (10) includes a panel (16) formed from a plurality of plies of material, specifically a base ply (50) made of an ethylene acrylic elastomer (VAMAC®), one passage-defining ply (52) made of square woven aramid fiber fabric (KEVLAR®) with an ethylene acrylic elastomer (VAMAC®) coating, another passage-defining ply (54) made of a knit aramid fiber fabric (NOMEX®) with an ethylene acrylic elastomer (VAMAC®) coating, and an outer ply (56) made of ethylene acrylic elastomer (VAMAC®). An additional outer ply (58) made of an elastomer (VAMAC®) or VITON®) can also be provided.

### RELATED APPLICATION

This application claims priority under 35 U.S.C. §119(e) to U.S. Provisional Patent Application No. 60/253,396 filed on Nov. 27, 2000. The entire disclosure of this provisional application is hereby incorporated by reference.

### FIELD OF THE INVENTION

This invention relates generally as indicated to an aircraft deicer and, more particularly, to a pneumatic deicer designed for use on the guide vane surfaces of jet engines.

### BACKGROUND OF THE INVENTION

An aircraft is periodically exposed to conditions of precipitation and low temperatures which can cause the forming of ice on the exposed surfaces. Of particular relevance to the present invention are the surfaces on the air inlet system of a jet engine, specifically internal guide vanes used to straighten the flow of air into the engine core. Under certain operating conditions, ice can form on these guide vane surfaces and, if the aircraft is to perform sufficiently in flight, it is important that this ice be removed.

One common method of ice removal involves the circulation of hot engine bleed air through passes internal to the vane structure. However, this removal method is not effective when there is a lack of bleed air availability. Accordingly, a pneumatic deicer is often the preferred ice removal method. A pneumatic deicer typically includes a panel with inflatable passages into which an inflation fluid (e.g., air) is repeatedly introduced and evacuated. A suitable deicer for this purpose is disclosed in U.S. Pat. No. 5,112,011, the entire disclosure of which is hereby incorporated by reference.

Thus, under certain operating conditions, ice can form on the guide vane surfaces. Under other operating conditions, however, dry air impinges on the surfaces and this can cause elevated temperatures reaching up to about 400° F. Conventional pneumatic deicers, such as the one disclosed in U.S. Pat. No. 5,112,011, have panels made from nylon fabrics, neoprene sheets, and/or natural rubber elastomers and can sometimes only withstand a maximum continuous temperature of about 160° F.

### SUMMARY OF THE INVENTION

The present invention provides a pneumatic deicer which can withstand temperatures in excess of about 200° F., in excess of about 300° F. and in excess of about 400° F. whereby the deicer can be used, if desired, on the guide vane structures of jet engines. The high temperature tolerance of the deicer is accomplished by using aramid fabrics (NOMEX® and KEVLAR®) and either fluoroelastomers (VITON®) or ethylene acrylic elastomers (VAMAC®).

More particularly, the present invention provides a deicer for breaking up and removing accumulated ice on an ice-vulnerable surface of an aircraft. The deicer comprises a plurality of plies of material, at least some of the plies of material defining a plurality of expansible and contractible inflation passages and wherein at least some of the plies of material are made of VITON®) or VAMAC®. At least some of the plies (e.g., the passage-defining plies) are made of a VAMAC® coated fabric. More specifically, one passage-defining ply is made of VAMAC®) coated knit NOMEX® fabric and the other passage-defining ply is made of VAMAC® coated square woven KEVLAR® fabric. A base ply, (adapted to be secured to an aircraft surface by a suitable adhesive and/or cement) can be made of VAMAC®, and outer plies can be made of VAMAC® or VITON®.

These and other features of the invention are fully described and particularly pointed out in the claims. The following description and annexed drawings set forth in detail a certain illustrative embodiment of the invention, this embodiment being indicative of but one of the various ways in which the principles of the invention can be employed.

### DRAWINGS

FIG. 1 is schematic perspective view of a deicer according to the present invention installed on an aircraft.

FIG. 2 is a plan view of a panel of the deicer in a deflated condition.

FIG. 3 is an enlarged fragmentary sectional view of the panel taken along line 3-3 in FIG. 2.

FIG. 4 is a view similar to FIG. 3 except that the deicer is shown in an inflated condition.

### DETAILED DESCRIPTION

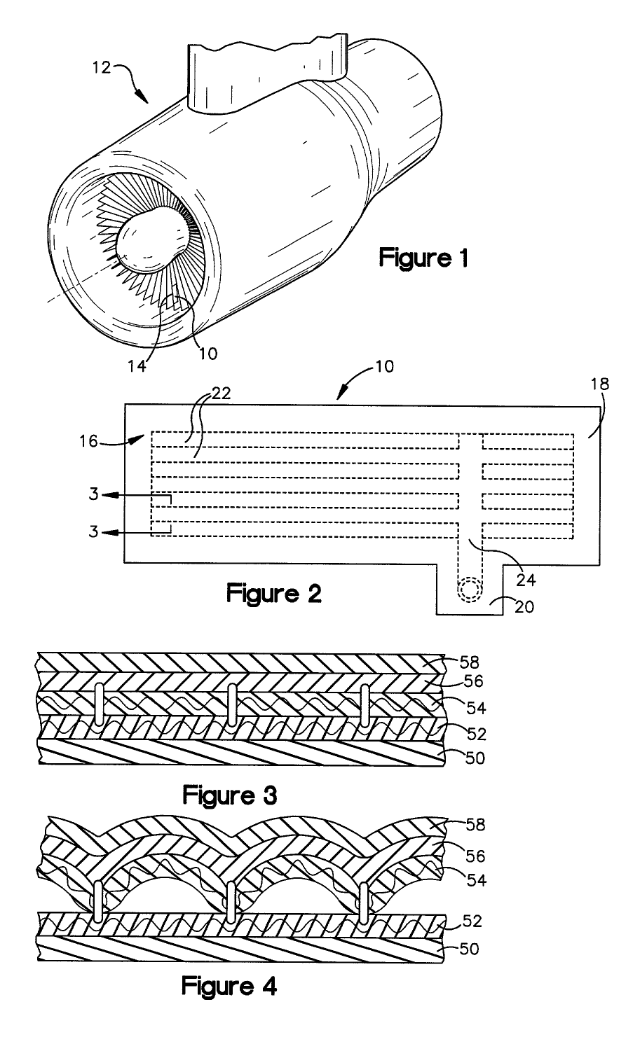

Referring now to the drawings in detail, and initially to FIG. 1, a deicer 10 according to the present invention is shown installed on an aircraft 12. More particularly, the deicer 10 is installed on guide vanes 14 which are used to straighten the flow of air into the engine core. Under certain circumstances, ice can form on the guide vane surfaces. Under other operating conditions, warm dry air can impinge on the surface of the deicer and temperatures can reach or exceed about 200° F., about 300° F. or about 400° F.

Referring now to FIG. 2, the deicer 10 is shown prior to installation on the aircraft 12. The overall design of the deicer 10 is similar to the deicer disclosed in U.S. Pat. No. 5,112,011, the entire disclosure of which has already been incorporated by reference. Specifically, for example, the deicer 10 comprises a panel 16 having a main portion 18 and an extension portion 20, both of which are rectangular in the illustrated embodiment. A plurality of passages 22 extend across the main panel portion 18 which are inflated and deflated during deicing operation. Preferably, the passages 20 are spaced apart from about 0.25 inch to about 0.50 inch (about 0.64 cm to about 1.27 cm) to provide deicing tubes having a high ice fracture stress factor for shedding thin layers of ice.

A manifold passage 24 extends transverse to the passages 22 in the main panel portion 18 and into the extension panel portion 20. The manifold passage 24 communicates with the passages 22 and its distal end is connected to a inflation source such as an air pump. In this manner, the manifold 24 can provide inflation fluid to the passages 22 at appropriate pressure (e.g., 75 to 125 psi), at appropriate activation periods (e.g., 0.10 to 0.50 seconds) and at appropriate intervals (e.g., 10 to 15 seconds) whereby ice having an expected thickness (e.g., 0.02 to 0.04 inch) can be broken away during operation of the deicer. Further details of desirable dimensions, pressure, periods, and intervals are set forth in U.S. Pat. No. 5,112,011, the entire disclosure of which has already been incorporated by reference.

Referring now to FIGS. 3 and 4, sectional views of the panel 16 are illustrated and, as shown, the panel 16 comprises a series of laminated plies 50, 52, 54, 56 and 58. Ply 50 is secured to the aircraft surface by a suitable adhesive and/or cement, plies 52 and 54 define the passages 22 and 24, and plies 56 and 58 form the exterior surface of the deicer 10.

The passages 22 and 24 are formed in the plies 52 and 54 by rows of stitching (see FIG. 2) whereby the passage-defining plies 52 and 54 have stitches 60 extending therethrough. The ply 52 is non-extensible and the ply 54 is extensible so that, as is shown in FIG. 4, the ply 52 remains flat during inflation while the ply 54 moves outward to form a roughly semi-circular (in cross-section) deicer tube. The outer plies 56 and 58 are also extensible so that they can move with the ply 54 during inflation of the passages 22.

The plies 50, 52, 54, 56 and 58 are each made of a material suitable for its intended purpose and/or to provide physical properties important for pneumatic deicing purposes. These include, for example, low air permeability, resilience for snap back during deflation, inter-laminar adhesion at an appropriate range of operating temperatures, good weathering resistance to ozone/airborne chemical pollutant, electrical properties to bleed off static electrical charge, good resistance to chemical solvents and fluids, and resistance to abrasion due to impinging sand particles and rain droplets.

The plies 50, 52, 54, 56 and 58 are also each made of material(s) which can withstand temperatures in excess of about 200° F., in excess of about 300° F. and in excess of about 400° F., as well as the low ice-producing temperatures. These materials include elastomers such as fluoroelastomers and/or ethylene acrylic elastomers, and fabrics such as aramid fiber weaves and/or knits. Fluoroelastomers useful in the present invention are a class of copolymers and terpolymers of vinylidenefluoride hexafluoropropylene and tetrafluoroethylene, known commercially under various designations as VITON A®, VITON EE, VITON E60C®, VITON E430®, VITON 910®, VITON GH® and VITON GF®. An ethylene acrylic elastomer useful in the present invention is a copolymer of ethylene and methyl acrylate plus a third monomer containing carboxylic curing sites, known commercially under various designations as VAMAC-B-124®, VAMAC N-123®, and VAMAC MGB-124®). Aramid fibers useful in the present invention include poly(m-phenylene isophthalamide) known commercially under the designation NOMEX® and Poly(p-phenylene teraphthalamide) known commercially under the designation KEVLAR®. KEVLAR® is a product of the condensation of terephthalic acid and p-phenylenedianine and NOMEX® is a product of the condensation of isophthalic acid and m-phenylenediamine. These designated products are trademarked and sold by E.I. DuPont de Numours & Company.

In the illustrated embodiment, the ply 50 is made of VAMAC® (0.035 inch gage), the ply 52 is a square woven KEVLAR® fabric with a VAMAC® coating (0.012 inch gage), the ply 54 is a knit NOMEX® fabric with a VAMAC® coating (0.020 inch gage), the ply 56 is made of VAMAC® (0.010 inch gage), and the ply 58 is made of VITON® or VAMAC® (0.010 inch gage). These thicknesses (gages) can be varied to meet specific end uses and tolerances.

By way of example, the fabric core of the deicer 10 could be constructed by treating the woven fabric ply 52 with nitrile phenolic adhesive, laminating one side of the treated ply 52 with a 10 mil ply of nitrile phenolic film, and placing a separator (e.g., Teflon tape) on the other side of the treated ply 52. The fabric ply 54 could be treated with an epoxy primer. The plies 52 and 54 could then be sewed together with the desired inflation tube configuration. Two coats of VAMAC® could then applied to the sewn fabric core and allowed to dry.

To assemble the other layers of the deicer 10 onto the fabric core, the outer ply 58 (e.g. 10 mil of VITON®) could be laminated to build metal, followed by applying two coats of VITON®NAMAC® tie in cement and applying two coats of VAMAC® cement. The outer ply 56 (e.g., 10 mil of VAMAC®) could be laminated thereon followed the application of one coat of VAMAC® cement so that the fabric core (plies 52 and 54) could then be laminated thereon, breezeside down. One coat of VAMAC® cement could be applied so that the base ply 50 (e.g., 35 mil VAMAC®) could be laminated to the periphery of the fabric core to make full thickness edges. One coat of VAMAC® cement could be applied to the edges and the base play 50 laminated to the bondside of the fabric core and the full thickness edges. The air connection hole could then be located and the appropriate insertion (e.g., a plug) made.

The assembled/laminated plies 50, 52, 54, 56, and 58 could then be cured. For example, the assembled/laminated plies could be placed in a vacuum bag and cured at 90 psi for 30 minutes at 350° F. Slow rise and slow cool down ramps could be used to eliminate voids. The air connection hole could then be opened and the assembled/laminated (and now cured) plies could be post cured in an oven for four hours at 350° using a slow rise and cool down.

Although the invention has been shown and described with respect to a certain preferred embodiment, equivalent and obvious alterations and modifications will occur to others skilled in the art upon the reading and understanding of this specification. The present invention includes all such alterations and modifications and is limited only by the scope of the following claims.

1. A deicer for breaking up and removing accumulated ice on an aircraft surface, the deicer comprises a plurality of plies of material, at least some of the plies of material defining a plurality of expansible and contractible inflation passages and wherein at least some of the plies of material are made of an elastomer which is either a fluoroelastomer or an ethylene acrylic elastomer.

2. A deicer as set forth in claim 1, wherein the elastomer is a fluoroelastomer which is a copolymer of vinylidenefluoride and hexafluoropropylene.

3. A deicer as set forth in claim 1, wherein the elastomer is an ethylene acrylic elastomer which is a copolymer of ethylene and methyl acrylate plus a third monomer containing carboxylic curing sites.

4. A deicer as set forth in claim 1, wherein at least some of the plies of material are made of a fabric coated with an ethylene acrylic elastomer.

5. A deicer as set forth in claim 1, wherein the passage-defining plies are each made of a fabric with an ethylene acrylic elastomer coating.

6. A deicer as set forth in claim 4, wherein one of the passage-defining plies comprises a knit aramid fabric.

7. A deicer as set forth in claim 6 wherein the aramid fabric is the product of the condensation of isophthalic acid and m-phenylenediamine

8. A deicer as set forth in claim 6, wherein the other passage-defining ply comprises a square woven aramid fabric.

9. A deicer as set forth in claim 8, wherein the square woven aramid fabric is the product of the condensation of terephthalic acid and p-phenylenedianine.

10. A deicer as set forth in claim 5, wherein stitching between the passage-defining plies defines the inflation passages.

11. A deicer as set forth in claim 1, wherein the plurality of plies comprises a base ply adapted to be secured an aircraft surface by a suitable adhesive and/or cement; passage-defining plies through which stitching passes to define the inflation passages; and at least one outer ply.

12. A deicer as set forth in claim 11, wherein base ply comprises ethylene acrylic elastomer, one of the passage-defining plies comprises square woven aramid fabric with an ethylene acrylic elastomer coating, the other of the passage-defining plies comprises knit aramid fabric with an ethylene acrylic elastomer coating, and the outer ply comprises ethylene acrylic elastomer.

13. A deicer as set forth in claim 12, wherein the woven aramid fabric is a product of the condensation of terephthalic acid and p-phenylenedianine and wherein the knit aramid fabric is a product of the condensation of isophthalic acid and m-phenylenediamine.

14. A deicer as set forth in claim 13, including another outer ply, this ply also being made of an elastomer which is either a fluoroelastomers or an ethylene acrylic elastomer.

15. A deicer as set forth in claim 14, wherein the outer ply elastomer is a fluoroelastomers which is a copolymer of vinylidenefluoride and hexafluoropropylene.

16. A deicer as set forth in claim 14, wherein the outer ply elastomer is an ethylene acrylic elastomer which is a copolymer of ethylene and methyl acrylate plus a third monomer containing carboxylic curing sites.

17. In combination, the pneumatic deicer of claim 1 and an aircraft, the deicer being installed on an ice-vulnerable surface of the aircraft.

18. The combination as set forth in claim 17, wherein the icevulnerable surface of the aircraft comprises guide vanes.

19. A method of using the pneumatic deicer of claim 1 comprising the steps of:
mounting the deicer on an ice-vulnerable surface of the aircraft; and
inflating and deflating the inflation passages.

20. A method as set forth in claim 19, wherein said ice-vulnerable surface of the aircraft comprises guide vanes.

21. A deicer for breaking up and removing accumulated ice on an aircraft surface, the deicer comprises a panel made from a plurality of plies of material which can withstand temperatures in excess of about 200° F.

22. A deicer as set forth in claim 21 wherein the plurality of plies of material can withstand temperatures in excess of about 300° F.

23. A deicer as set forth in claim 22, wherein the plurality of plies of material can withstand temperatures in excess of about 400° F.

24. A deicer as set forth in claim 21, wherein the plurality of plies comprises a base ply adapted to be secured an aircraft surface by a suitable adhesive and/or cement; passage-defining plies through which stitching passes to define the inflation passages; and at least one outer ply.

25. A deicer as set forth in claim 24, wherein base ply comprises ethylene acrylic elastomer, one of the passage-defining plies comprises square woven aramid fabric with an ethylene acrylic elastomer coating, the other of the passage-defining plies comprises knit aramid fabric with an ethylene acrylic elastomer coating, and the outer ply comprises ethylene acrylic elastomer.

26. A deicer as set forth in claim 25, wherein the woven aramid fabric is a product of the condensation of terephthalic acid and p-phenylenedianine and wherein the knit aramid fabric is a product of the condensation of isophthalic acid and m-phenylenediamine.

27. A deicer as set forth in claim 26, including another outer ply, this ply also being made of an elastomer which is either a fluoroelastomers or an ethylene acrylic elastomer.

28. A deicer as set forth in claim 27, wherein the outer ply elastomer is a fluoroelastomers which is a copolymer of vinylidenefluoride and hexafluoropropylene.

29. A deicer as set forth in claim 27, wherein the outer ply elastomer is an ethylene acrylic elastomer which is a copolymer of ethylene and methyl acrylate plus a third monomer containing carboxylic curing sites.

30. In combination, the pneumatic deicer of claim 21 and an aircraft, the deicer being installed on an ice-vulnerable surface of the aircraft.

31. The combination as set forth in claim 30, wherein the ice-vulnerable surface of the aircraft comprises guide vanes.

32. A method of using the pneumatic deicer of claim 21 comprising the steps of:
mounting the deicer on an ice-vulnerable surface of the aircraft; and
inflating and deflating the inflation passages.

33. A method as set forth in claim 32, wherein said ice-vulnerable surface of the aircraft comprises guide vanes.
